(19) United States
(12) Patent Application Publication
(10) Pub. No.: US 2015/0044969 A1
(43) Pub. Date: Feb. 12, 2015

(54) Wireless Transmission System and Method

(71) Applicant: Microchip Technology Incorporated, Chandler, AZ (US)

(72) Inventor: Chris Tucker, Peoria, AZ (US)

(21) Appl. No.: 14/453,013

(22) Filed: Aug. 6, 2014

Related U.S. Application Data
(60) Provisional application No. 61/864,239, filed on Aug. 9, 2013.

(51) Int. Cl. H04W 4/00; H04B 7/26

(52) U.S. Cl. CPC H04W 4/008; H04B 7/26
USPC 455/41.2

(57) ABSTRACT

Wireless transmission using BodyCom communications is a short-range wireless connectivity technology that uses the radio frequency (RF) transmission capability of the human body, or other materials having RF transmission capabilities, to transport radio frequency signals using safe and secure communications between two or more electronically compatible wireless devices.

### RELATED PATENT APPLICATION

This application claims priority to commonly owned U.S. Provisional Patent Application Ser. No. 61/864,239; filed Aug. 9, 2013; which is hereby incorporated by reference herein for all purposes.

### TECHNICAL FIELD

The present disclosure relates to a method and system for wireless transmission used in communicating data, in particular, a wireless transmission system and method using radio frequency transmission mediums, e.g., conductive materials such as building structures or a flesh and blood body, in particular, a human body as the transmission medium.

### BACKGROUND

Traditional wireless systems rely on radio frequency (RF) links, e.g., typically 400 to 900 MHz, or IEEE 802.11 Gigahertz (GHz) frequencies. While providing the convenience of remote control, these systems also require manual activation by the user and an additional level of security to prevent “sniffing” of the security codes during RF transmissions. While these limitations are surmountable, they can be challenging for both the designer and the user, for example, when the user is trying to enter their house during a rain storm while holding a brief case and a bag of groceries.

### SUMMARY

Therefore a need exists for a more secure and “hands free” wireless transmission system and method.

According to an embodiment, a wireless transmission system may comprise: a mobile unit that may comprise a mobile capacitive coupling element, a high frequency transmitter coupled to the mobile capacitive coupling element, and a low frequency receiver coupled to the mobile capacitive coupling element; and a base unit may comprise a base capacitive coupling element and proximity sensor, a proximity detector coupled to the base capacitive coupling element and proximity sensor, a low frequency transmitter coupled to the base capacitive coupling element and proximity sensor, and a high frequency receiver coupled to the base capacitive coupling element and proximity sensor; wherein when the mobile capacitive coupling element of the mobile unit may be in close proximity to the base capacitive coupling element and proximity sensor, the proximity detector may cause the base unit to transmit a low frequency signal that may be received by the mobile unit, and the mobile unit may respond by transmitting a high frequency signal that may be received by the base unit, whereby wireless communications may be established therebetween.

According to a further embodiment, the mobile unit may store bootloader updates for the base unit and, when in communications with the base unit, may transfer the bootloader updates thereto. According to a further embodiment, the mobile unit may receive operational and test information from the base unit. According to a further embodiment, the mobile unit may store the received operational and test information of the base unit. According to a further embodiment, the mobile unit may display the stored operational and test information of the base unit.

According to another embodiment, a method for wireless transmission may comprise the steps of: providing a mobile unit that may comprise a mobile capacitive coupling element, a high frequency transmitter coupled to the mobile capacitive coupling element, and a low frequency receiver coupled to the mobile capacitive coupling element; and providing a base unit that may comprise a base capacitive coupling element and proximity sensor, a proximity detector coupled to the base capacitive coupling element and proximity sensor, a low frequency transmitter coupled to the base capacitive coupling element and proximity sensor, and a high frequency receiver coupled to the base capacitive coupling element and proximity sensor; locating the mobile capacitive coupling element of the mobile unit in close proximity to the base capacitive coupling element and proximity sensor; detecting the presence of the mobile unit in close proximity to the base capacitive coupling element and proximity sensor; transmitting a low frequency signal from the base unit to the mobile unit; and transmitting a high frequency signal from the mobile unit to the base unit, wherein wireless communications may be established therebetween.

According to a further embodiment of the method, may comprise the steps of: storing bootloader updates for the base unit in the mobile unit; and transferring the bootloader updates stored in the mobile unit to the base unit.

According to yet another embodiment, a wireless transmission system may comprise: a mobile unit that may comprise a mobile capacitive coupling element, a high frequency transmitter coupled to the mobile capacitive coupling element, and a low frequency receiver coupled to the mobile capacitive coupling element, wherein the mobile capacitive coupling element may be in close proximity to a user; a plurality of base capacitive coupling elements and proximity sensors arranged in areas accessible to the user; and a base unit that may comprise at least one proximity detector coupled to respective ones of the plurality of base capacitive coupling elements and proximity sensors, a low frequency transmitter selectively coupled to respective ones of the plurality of base capacitive coupling elements and proximity sensors, and a high frequency receiver selectively coupled to the respective ones of the plurality of base capacitive coupling elements and proximity sensors; wherein when the user may be in close proximity to at least one of the plurality of base capacitive coupling elements and proximity sensors, at least one of the plurality of proximity sensors causes the base unit to transmit a low frequency signal through that at least one of the plurality of base capacitive coupling elements and proximity sensors that may be received by the mobile unit, and the mobile unit may respond by transmitting a high frequency signal that may be received by the base unit, whereby wireless communications may be established therebetween.

According to a further embodiment, the base unit may store bootloader updates for the mobile unit and, when in communications with the mobile unit, may transfer the bootloader updates thereto. According to a further embodiment, the base unit may determine a location of the user based upon which one of the plurality of base capacitive coupling elements and proximity sensors the user may be proximate to. According to a further embodiment, the base unit may determine a direction and speed of the user based upon which ones of the plurality of base capacitive coupling elements and proximity sensors the user may be proximate to. According to a further embodiment, secure information may be sent from the base unit to the mobile unit but not displayed on the mobile unit when the user may be in an unsecured portion of the area. According to a further embodiment, secure information may be sent from the base unit to the mobile unit and displayed on the mobile unit when the user may be in a secure portion of the area. According to a further embodiment, non-secure information may be sent from the base unit to the mobile unit and displayed on the mobile unit. According to a further embodiment, the base unit communicates with the mobile unit through the at least one of the plurality of base capacitive coupling elements and proximity sensors having proximity detection therefrom. According to a further embodiment, the at least one proximity detector selectively coupled to the respective ones of the plurality of master capacitive coupling elements and proximity sensors may be a plurality of proximity detectors coupled to the respective ones of the plurality of master capacitive coupling elements and proximity sensors.

According to still another embodiment, a method for wireless transmission may comprise the steps of: providing a mobile unit that may comprise a mobile capacitive coupling element, a high frequency transmitter coupled to the mobile capacitive coupling element, and a low frequency receiver coupled to the mobile capacitive coupling element, wherein the mobile capacitive coupling element may be in close proximity to a user; providing a plurality of base capacitive coupling elements and proximity sensors arranged in areas accessible to the user; and providing a base unit that may comprise at least one proximity detector coupled to respective ones of the plurality of base capacitive coupling elements and proximity sensors, a low frequency transmitter selectively coupled to respective ones of the plurality of base capacitive coupling elements and proximity sensors, and a high frequency receiver selectively coupled to the respective ones of the plurality of base capacitive coupling elements and proximity sensors; sensing when the user may be in close proximity to at least one of the plurality of base capacitive coupling elements and proximity sensors; transmitting a low frequency signal through that at least one of the plurality of base capacitive coupling elements and proximity sensors and over the user's body to the mobile unit; and transmitting a high frequency signal from the mobile unit and over the user's body to the base unit, wherein wireless communications may be established therebetween.

According to a further embodiment of the method, may comprise the steps of: providing a manager unit that may comprise a manager capacitive coupling element, a high frequency transmitter may be coupled to the manager capacitive coupling element, and a low frequency receiver may be coupled to the manager capacitive coupling element, wherein the manager capacitive coupling element may be in close proximity to the user;

According to another embodiment, a wireless transmission system may comprise: at least one slave unit, each of the at least one slave units may comprise a slave capacitive coupling element, a high frequency transmitter coupled to the slave capacitive coupling element, and a low frequency receiver coupled to the slave capacitive coupling element, wherein the slave capacitive coupling element may be in close proximity to a user; a manager unit may comprise a manager capacitive coupling element, a high frequency transmitter and receiver coupled to the manager capacitive coupling element, and a low frequency transmitter and receiver coupled to the manager capacitive coupling element, wherein the manager capacitive coupling element may be in close proximity to the user; a plurality of master capacitive coupling elements and proximity sensors arranged in areas accessible to the user; and a master unit may comprise at least one proximity detector coupled to respective ones of the plurality of master capacitive coupling elements and proximity sensors, a low frequency transmitter selectively coupled to at least one of the plurality of master capacitive coupling elements and proximity sensors, and a high frequency receiver selectively coupled to the at least one of the plurality of master capacitive coupling elements and proximity sensors; wherein when the user may be in close proximity to at least one of the plurality of master capacitive coupling elements and proximity sensors, at least one of the plurality of proximity sensors may cause the master unit to transmit a low frequency signal that may be received by the manager unit, and the manager unit may respond by transmitting a high frequency signal that may be received by the master unit, whereby wireless communications may be established therebetween.

According to a further embodiment, the manager unit may communicate with the at least one slave unit over the user's body. According to a further embodiment, the at least one slave unit and the manager unit may collect personal preferences and setting of controllable appliances that may be used by the user. According to a further embodiment, the controllable appliances may be selected from the group consisting of room lighting, entertainment system, climate control, and security system. According to a further embodiment, time stamping events may be communicated between the slave, manager and master units. According to a further embodiment, the at least one proximity detector selectively coupled to the respective ones of the plurality of master capacitive coupling elements and proximity sensors may be a plurality of proximity detectors coupled to the respective ones of the plurality of master capacitive coupling elements and proximity sensors.

According to still another embodiment, a wireless transmission system may comprise: a plurality of slave units, each of the plurality of slave units may comprise a slave capacitive coupling element, a high frequency transmitter coupled to the slave capacitive coupling element, and a low frequency receiver coupled to the slave capacitive coupling element, wherein the slave capacitive coupling element may be in close proximity to a user; and a manager unit may comprise a manager capacitive coupling element, a high frequency transmitter and receiver coupled to the manager capacitive coupling element, and a low frequency transmitter and receiver coupled to the manager capacitive coupling element, wherein the manager capacitive coupling element may be in close proximity to the user; wherein the manager unit communicates with the plurality of slave units over the user's body.

According to a further embodiment, responses from the plurality of slave units to the manager unit may be synchronized. According to a further embodiment, synchronized responses from the plurality of slave units may be packed into packets for reception by the manager unit. According to a further embodiment, synchronized response packets may be encrypted.

According to another embodiment, a system for tracking authorized and unauthorized personnel may comprise: a plurality of base capacitive coupling elements and proximity sensors arranged in an area; a base unit that may comprise at least one proximity detector coupled to respective ones of the plurality of base capacitive coupling elements and proximity sensors, a low frequency transmitter selectively coupled to respective ones of the plurality of base capacitive coupling elements and proximity sensors, and a high frequency receiver selectively coupled to the respective ones of the plurality of base capacitive coupling elements and proximity sensors; when a person may be in close proximity to at least one of the plurality of base capacitive coupling elements and proximity sensors, at least one of the plurality of proximity sensors may cause the base unit to transmit a low frequency signal through that at least one of the plurality of base capacitive coupling elements and proximity sensors to a mobile unit wherein if a high frequency signal response from the mobile unit may be received by the base unit, then wireless communications may be established therebetween and that person may be authorized to be in the area of the respective one of the plurality of base capacitive coupling elements and proximity sensors, and if no high frequency signal response from the mobile unit may be received by the base unit, then that person may be unauthorized to be in that area.

According to a further embodiment, the mobile unit may comprise a mobile capacitive coupling element, a high frequency transmitter coupled to the mobile capacitive coupling element, and a low frequency receiver coupled to the mobile capacitive coupling element, wherein the mobile capacitive coupling element may be in close proximity to an authorized person. According to a further embodiment, at least one security camera may be activated when an unauthorized person may be in the area. According to a further embodiment, at least one security alarm may be activated when an unauthorized person may be in the area.

According to yet another embodiment, a method for tracking authorized and unauthorized personnel may comprise the steps of: providing a plurality of base capacitive coupling elements and proximity sensors arranged in an area; providing a base unit that comprise at least one proximity detector coupled to respective ones of the plurality of base capacitive coupling elements and proximity sensors, a low frequency transmitter selectively coupled to respective ones of the plurality of base capacitive coupling elements and proximity sensors, and a high frequency receiver selectively coupled to the respective ones of the plurality of base capacitive coupling elements and proximity sensors; detecting when a person may be in close proximity to at least one of the plurality of base capacitive coupling elements and proximity sensors; transmitting a low frequency signal through that at least one of the plurality of base capacitive coupling elements and proximity sensors to a mobile unit; determining whether a high frequency signal response from the mobile unit may be received by the base unit, if so, then that person may be authorized to be in the area of the respective one of the plurality of base capacitive coupling elements and proximity sensors, and if not, then that person may be unauthorized to be in that area.

According to still another embodiment, a wireless transmission system may comprise: a plurality of units, each of the plurality of units may comprise a capacitive coupling element, a high frequency transmitter and receiver coupled to the capacitive coupling element, and a low frequency transmitter and receiver may be coupled to the capacitive coupling element; each of the capacitive coupling elements may be in close proximity to a respective user; wherein at least two of the plurality of units may communicate over the respective users' bodies.

According to a further embodiment, the at least two of the plurality of units exchange a synchronized packet. According to a further embodiment, the synchronized packet has a priority assigned to each one of the plurality of units.

According to another embodiment, an infrastructure wireless communications system may comprise: at least one slave node, each of the at least one slave nodes may comprise a slave node capacitive coupling element in close proximity to at least one radio frequency conductive structure in a building, a high frequency transmitter coupled to the slave node capacitive coupling element, and a low frequency receiver coupled to the slave node capacitive coupling element; a master unit may comprise a master capacitive coupling element in close proximity to the at least one radio frequency conductive structure, a low frequency transmitter selectively coupled to the master capacitive coupling element, and a high frequency receiver selectively coupled to the master capacitive coupling element; wherein the master unit may transmit a low frequency signal over the at least one radio frequency conductive structure that may be received by the at least one slave node unit, and the at least one slave node unit responds by transmitting a high frequency signal over the at least one radio frequency conductive structure that may be received by the master unit, whereby wireless communications may be established therebetween.

According to a further embodiment, a manager unit may comprise a manager capacitive coupling element in close proximity to the at least one radio frequency conductive structure, a high frequency transmitter and receiver coupled to the capacitive coupling element, and a low frequency transmitter and receiver coupled to the capacitive coupling element; wherein the manager unit may transmit a low frequency signal over the one radio frequency conductive structure that may be received by the at least one slave node unit, and the at least one slave node unit may respond by transmitting over the one radio frequency conductive structure a high frequency signal that may be received by the manager unit, whereby wireless communications may be established therebetween.

According to a further embodiment, the manager unit may communicate with the master unit over the at least one radio frequency conductive structure. According to a further embodiment, each of the at least one slave node units may comprise: a low frequency transmitter coupled to the slave node capacitive coupling element, and a high frequency receiver coupled to the slave node capacitive coupling element; wherein at least two of the slave node units communicate over the at least one radio frequency conductive structure. According to a further embodiment, the at least one slave node unit may be coupled to and controls equipment in the building. According to a further embodiment, the equipment may be selected from the group consisting of lights, security cameras, public address panel, intercom panel, and fire alarm panel. According to a further embodiment, each high and low frequency receiver may have a received signal strength indication (RSSI), wherein received signal strength may be available from of the at least one slave node unit and the manager unit to the master unit for determining distances and locations thereof.

According to yet another embodiment, a method for wirelessly communicating in a building may comprise the steps of: providing at least one slave node, each of the at least one slave nodes may comprise a slave node capacitive coupling element in close proximity to at least one radio frequency conductive structure in a building, a high frequency transmitter coupled to the slave node capacitive coupling element, and a low frequency receiver coupled to the slave node capacitive coupling element; providing a master unit that may comprise a master capacitive coupling element in close proximity to the at least one radio frequency conductive structure, a low frequency transmitter selectively coupled to the master capacitive coupling element, and a high frequency receiver selectively coupled to the master capacitive coupling element; transmitting a low frequency signal over the at least one radio frequency conductive structure with the master unit; receiving the low frequency signal with the at least one slave node unit; and transmitting a high frequency signal over the at least one radio frequency conductive structure with the at least one slave node unit.

According to a further embodiment of the method, may comprise the steps of: providing a manager unit that may comprise a manager capacitive coupling element in close proximity to the at least one radio frequency conductive structure, a high frequency transmitter and receiver coupled to the capacitive coupling element, and a low frequency transmitter and receiver coupled to the capacitive coupling element; transmitting a low frequency signal over the at least one radio frequency conductive structure with the manager unit; receiving the low frequency signal with the at least one slave node unit; and transmitting a high frequency signal over the at least one radio frequency conductive structure with the at least one slave node unit. According to a further embodiment of the method, the step of communicating between the manager unit and the master unit may be over the at least one radio frequency conductive structure. According to a further embodiment of the method, may comprise the steps of: coupling respective ones of the at least one slave node unit to building equipment; and controlling the building equipment with the respective ones of the at least one slave node units.

### BRIEF DESCRIPTION OF THE DRAWINGS

A more complete understanding of the present disclosure may be acquired by referring to the following description taken in conjunction with the accompanying drawings wherein:

FIG. 1 illustrates a schematic block diagram of a BodyCom system, according to the teachings of this disclosure;

FIG. 2 illustrates a schematic block diagram of a base unit, according to specific example embodiments of this disclosure;

FIG. 3 illustrates a schematic block diagram of a base unit detecting the presence of a body and communicating through the body with a mobile unit, according to specific example embodiments of this disclosure;

FIG. 4 illustrates a schematic block diagram of a BodyCom system used for boot-loading, inspection, monitoring and testing, according to a specific example embodiment of this disclosure;

FIG. 5 illustrates a schematic block diagram of a BodyCom system used for supplying roaming data collection and/or distribution, according to another specific example embodiment of this disclosure;

FIG. 6 illustrates a schematic block diagram of a BodyCom system comprising master, manager and slave devices, according to yet another specific example embodiment of this disclosure;

FIG. 7 illustrates a schematic block diagram of a BodyCom system using broadcast packet communications, according to still another specific example embodiment of this disclosure;

FIG. 8 illustrates a schematic block diagram of a BodyCom system implementation for localized tracking of people, according to another specific example embodiment of this disclosure;

FIG. 9 illustrates a diagram of a BodyCom system providing infrastructure node communications, according yet another specific example embodiment of this disclosure; and

FIG. 10 illustrates a schematic block diagram of a position and range determination system based upon BodyCom communications received signal strength indication (RSSI), according to still another specific example embodiment of this disclosure.

While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein, but on the contrary, this disclosure is to cover all modifications and equivalents as defined by the appended claims.

### DETAILED DESCRIPTION

BodyCom overcomes the aforementioned wireless systems limitations by using a user's body and/or RF conductive materials as a medium for RF signal transmission. The BodyCom communications system is a short-range wireless connectivity technology that uses the radio frequency (RF) transmission capability of the human body, or other materials having RF transmission capabilities, to transport radio frequency signals that provide intuitive, simple, and safe communications between two or more electronically compatible wireless devices. Communication between BodyCom system devices may occur when they are proximate to, e.g., within a few centimeters of, a human body: simple proximity or touch detection may establish a BodyCom system connection. BodyCom technology is more fully described in Microchip Technology Incorporated Application Note AN1391 “Introduction to the BodyCom Technology,” (2011), available at www.microchip.com, and its content in its entirety is hereby incorporated by reference herein for all purposes. BODYCOM™ is a pending Federal trademark application owned by Microchip Technology Incorporated, a corporation registered in the state of Delaware, and having an address of 2355 West Chandler Boulevard, Chandler, Ariz. 85224-6199.

Capacitive proximity detection is more fully described in various publications available at applicant's website www.microchip.com, for example but are not limited to, Application Notes AN1325 “mTouch Metal Over Cap Technology,” AN1334 “Techniques for Robust Touch Sensing Design,” AN1478 “mTouch Sensing Solution Acquisition Methods Capacitive Voltage Divider,” AN1492 “Microchip Capacitive Proximity Design Guide,” AN1626 “Implementing Metal Over Capacitive Touch Sensors;” and specification sheet for MTICH101 “Single-Channel Proximity Detector,” all of which are hereby incorporated by reference herein for all purposes.

According to various embodiments, BodyCom technology may be implemented into field applications and functionally replace wires on new and/or existing wireless systems, whereby security may be increased while keeping costs to a minimal. “Base unit” and “master unit” may be used interchangeable herein. “Mobile unit” and “slave unit” may be used interchangeable herein.

Referring now to the drawings, the details of example embodiments are schematically illustrated. Like elements in the drawings will be represented by like numbers, and similar elements will be represented by like numbers with a different lower case letter suffix.

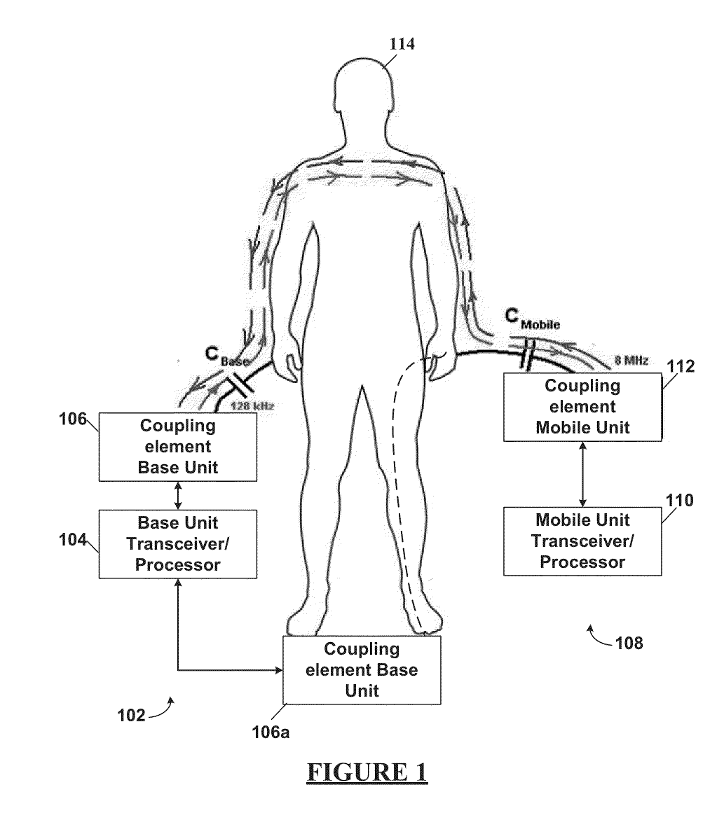

Referring to FIG. 1, depicted is a schematic block diagram of a BodyCom system, according to the teachings of this disclosure. The BodyCom system may comprise a base unit 102 and a mobile unit 108. The base unit 102 may comprise a base unit transceiver/processor 104 and a coupling element 106 connected thereto. The mobile unit 108 may comprise a mobile unit transceiver/processor 110 and a coupling element 112 connected thereto. When the body 114 of a person (user) comes in close proximity to the base and mobile coupling elements 106 and 112, respectively, a BodyCom communications link may be established. Data may be capacitively coupled between the base unit coupling element 106 and the mobile unit coupling element 1112 through the user's body 114 using, for example but is not limited to, a low-frequency Amplitude Shift Key (ASK) format whenever the user's body 114 and the base unit coupling element 106 are proximate to each another. The user's touch may also create simple capacitive touch detection with the coupling elements 106 and/or 112 to initiate the challenge and response sequence between the base and mobile units' transceiver/processors 104 and 110 whenever the user's body 114 is proximate to the respective coupling elements 106 and/or 112.

Due to the high RF permittivity of the human body 114 at low frequencies, RF transmissions may be achieved with a simple, easily-designed system operating from about 60 kHz to about 30 MHz. Since data between the base and mobile units 102 and 108 is coupled through the body 114 of a user, there are substantially no RF transmission detection security issues, and the touch initiation system removes the need for manually triggering a connection sequence between the base and mobile units 102 and 108. The BodyCom system provides an easy-to-use system that is secure to use and easy to design, layout and produce. The BodyCom system may provide the following features and advantages: 1) very low consumption, especially for the mobile unit 108, 2) fast system response time, 3) stable and robust communication with fault detection, 4) limited field of action (as little as a few centimeters) to allow an identification when a touch or proximity action takes place from whoever wears the mobile unit 108, and 5) low cost and complexity of base 102 and mobile 108 units.

The BodyCom RF signal transmission uses capacitive coupling between the human body 114, the base unit 102 and the mobile unit 108 as shown in FIG. 1. Because of this, the RF signals are more attenuated at low frequencies than at high frequencies, requiring the signals that are transmitted to have higher amplitude for the lower frequencies. The mobile unit 108 may be a battery-powered portable device, and power consumption is therefore a priority, while the base unit 102 may have more power available to it.

Another constraint in frequency choice is the result of the mobile unit transceiver/processor's 110 power consumption in receive mode. This is a result of the limited low-power receiver circuits available on the market, which may limit the receiving frequency to the 60-400 kHz range. That, in addition to the low-power consumption in transmission mode demanded by the mobile unit transceiver/processor 110, it is preferable to use a frequency between from about 6 MHz to about 13 MHz for the transmitting channel (the relation between the power consumption and the performance may be optimum within that frequency range). A frequency of about 128 kHz may be been chosen for the channel transmitted from the base unit transceiver/processor 104 and received by the mobile unit transceiver/processor 110. A frequency of about 8 MHz may be been chosen for the channel transmitted from the mobile unit transceiver/processor 110 and received by the base unit transceiver/processor 104 (frequency selection may be available with an on-chip (programmable) oscillator of an integrated circuit microcontroller).

Base-to-Mobile Transmission

For base-to-mobile transmission in a BodyCom system, the communication may be initiated by the base unit transceiver/processor 104. In order to start a communication when the BodyCom system is coupled with the human body 114 only, a digital processor, e.g., microcontroller, may perform proximity (e.g., touch) detection frequently or even continuously. When a touch is detected by the base unit transceiver/processor 104, touch detection stops and a RF transmission may be initiated to search for a mobile unit 110. This generated sequence may be applied through a digital driver in the base unit transceiver/processor 104 to an inductor-capacitor (LC) circuit (not shown) working in a resonant mode. This LC circuit (not shown) may be connected to the coupling pad (element) 106 that then transfers the low frequency RF signal to the human body 114. In this way, the human body 114 becomes an extension of the coupling element 106, allowing the transfer of the low frequency RF signal to the coupling element 112 of the mobile unit transceiver/processor 110 that may be in proximity with the human body 114. A touch is considered herein to be when the human body 114 and a coupling element are in close proximity to one another. Actual physical contact is not necessary and there may be intermediate layers of clothing, shoe leather, gloves, etc., located between the human body 114 and a coupling element (106, 112).

As previously mentioned, as the base unit 108 can deliver more power to its transmitting channel, a low frequency, e.g., 128 kHz, may be used for the base unit 108 transmitting channel. This is possible because the base unit 108, being a fixed part of the system, may be powered externally or can have a bigger battery attached thereto. The signal generated by the base unit 108 will be transmitted to the mobile unit via the body 114, which is typically waiting in a signal receive mode (low-power consumption). The signal transmitted from the base unit 108 will be received by the mobile unit 110 receiver (not shown) and may cause a wake-up of the mobile unit 110.

Mobile-to-Base Response

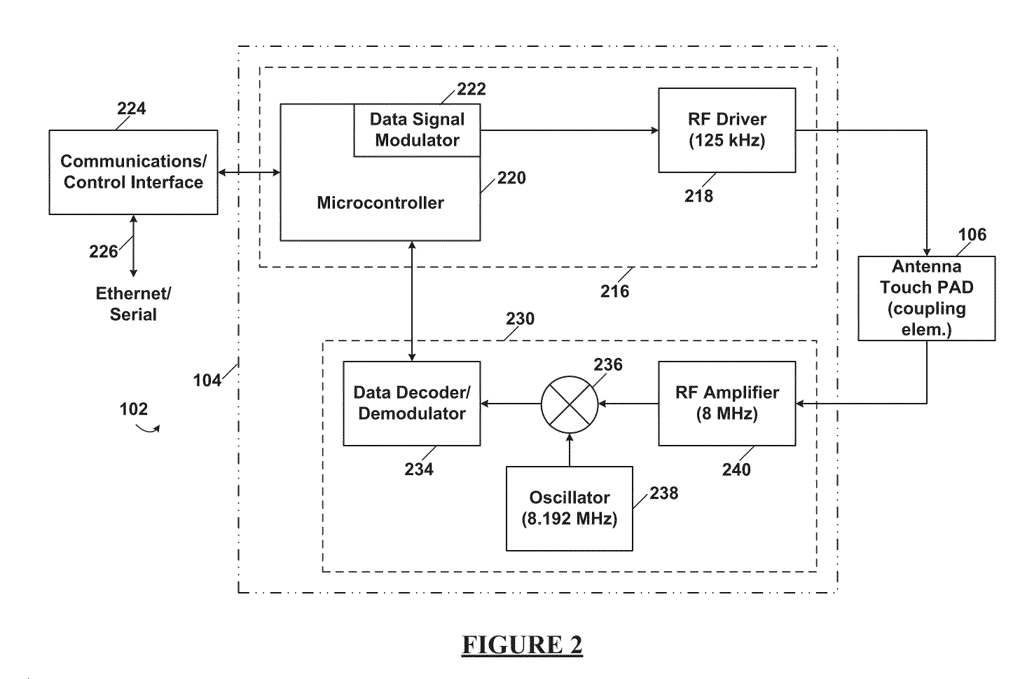

After the signal transmitted from the base unit transceiver/processor 104 is received by the mobile unit transceiver/processor 110, it decodes the data and, if a response is necessary, will respond. The mobile unit transceiver/processor 110 may also be capacitively coupled with the human body 114 through the associated coupling element 112. It is preferable that the mobile unit transceiver/processor 110 use the lowest power consumption in its transmission mode and have more efficient signal coupling, therefore transmitting at high frequencies is preferred. High frequency signals are readily available from a microcontroller and may be used to generate, for example but is not limited to, a transmitting signal at about 8 Mhz. The response is sent by the mobile unit transceiver/processor 110 operating at the high frequency, e.g., about 8 MHz; the signal is carried by the human body 114 to the vicinity of the base unit 102 and may be applied through the coupling element 106 to the receiver (FIG. 2) in the base unit transceiver/processor 104.

Referring to FIG. 2, depicted is a block diagram of a base unit, according to specific example embodiments of this disclosure. The base unit, generally represented by the numeral 102 may comprise a low frequency transmitter 216, a high frequency receiver 226, a coupling element/touch pad 106, and a communications and control interface 224 that may have an Ethernet and/or serial communications port 226. The low frequency transmitter 216 may comprise a data modulator 222, and a RF driver 218. The data modulator 222 may be provided in a microcontroller 220. The high frequency receiver 230 may comprise a RF amplifier 240, a frequency translation mixer 236, an oscillator 238, signal filtering (not shown), and a data decoder/demodulator 234. The demodulated output from the data decoder/demodulator 234 may be coupled to the microcontroller 220, and can receive a complete data sequence and decode incoming data transmitted from the mobile unit 108.

The base unit 102 may be adapted to perform the following functions: 1) touch/proximity detection, 2) send a challenge to the mobile unit 108, 3) receive and decode incoming data, and 4) provide a simple communication/control interface 224 for easy integration with other systems that may be coupled over the communications port 226. The low frequency transmitter 216 and the high frequency receiver 230 may be managed (controlled) by the microcontroller 220. Wherein the microcontroller can manage the transmission/receiving process, perform encoding/decoding and error detection. In addition, the microcontroller 220 may support implementation of a security algorithm for secure communication. The transmitter 230 may drive the coupling element 106 that may further support additional touch/proximity detection (see Microchip Application Note AN1391). A simple serial interface 224 may be provided for connection to other systems or microcontrollers for ease in integration and design flexibility.

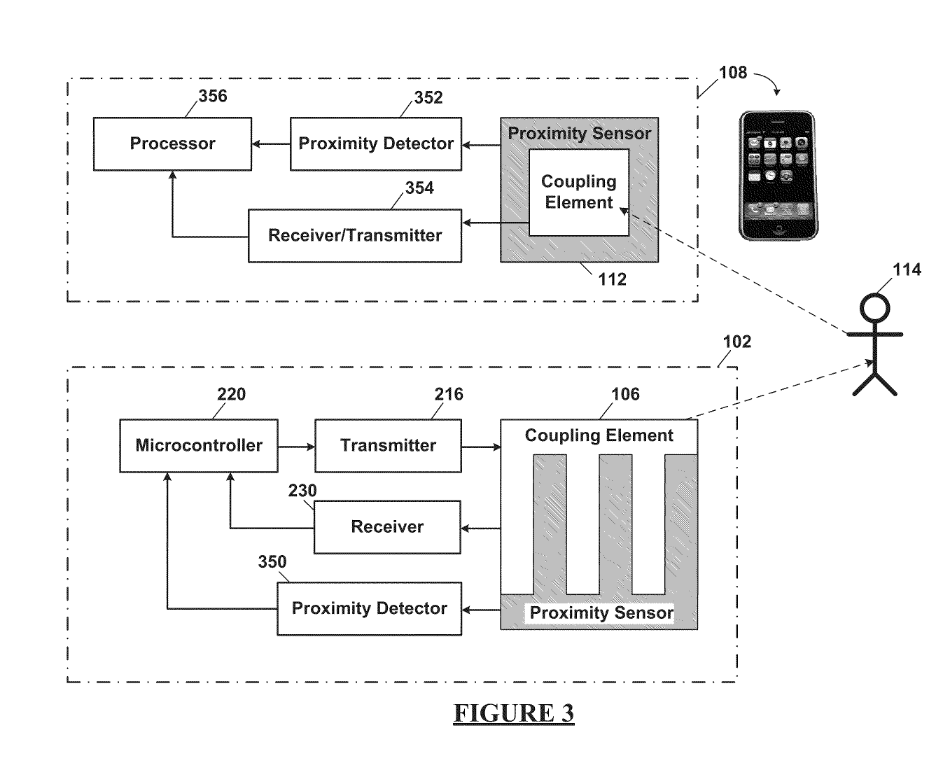

Referring to FIG. 3, depicted is a schematic block diagram of a base unit detecting the presence of a body and communicating through the body with a mobile unit, according to specific example embodiments of this disclosure. The mobile unit 108 may comprise the coupling element 112 that may also function as a proximity sensor, a proximity detector 352, a receiver/transmitter 354, and a processor. The proximity detector 352 in combination with the coupling element 112 acting as a proximity sensor that can sense an object, e.g., a hand or torso of a body 106, and may use this proximity sensing and detection to wake-up circuits that are in a low power sleep mode. The wake-up functions described hereinabove are optional and may be used to conserve power in a battery operated device, e.g., cell phone, touch pad PC, etc.

Referring now to the base unit 102, the proximity detector 350 in combination with the coupling element 106 acting as a proximity sensor senses an object, e.g., a hand or foot of the body 114, in close proximity or touching by a change in the capacitance value of the coupling element 106, and may use this proximity sensing and detection to send out interrogation signals to the mobile unit 108.

Bootloading, Inspection, Monitoring and Testing

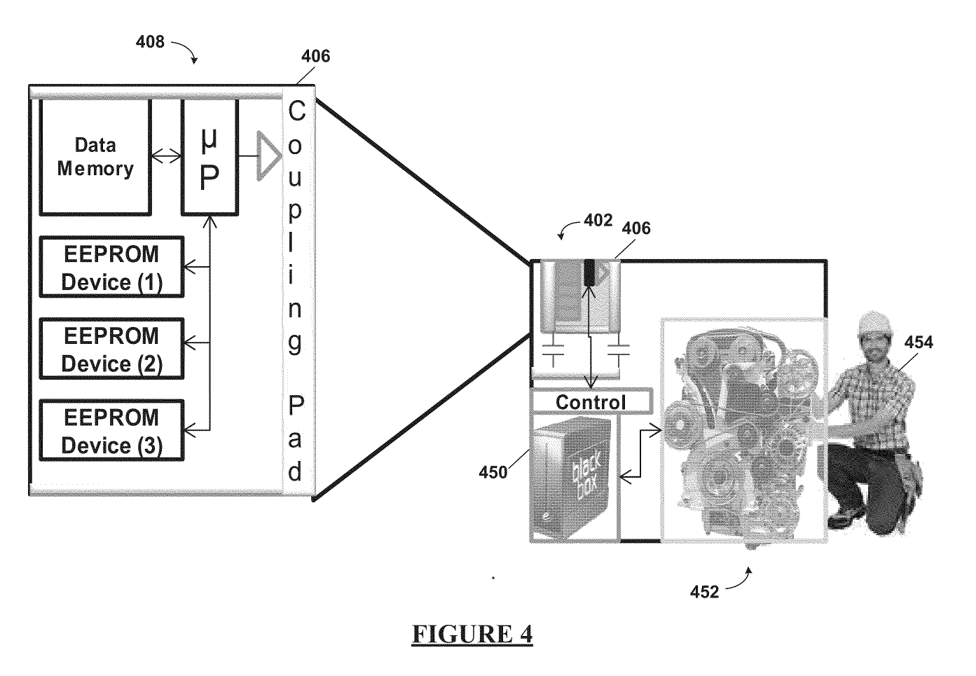

Referring to FIG. 4, depicted is a schematic block diagram of a BodyCom system used for bootloading, inspection, monitoring and testing, according to a specific example embodiment of this disclosure. A mobile unit 408 may be designed to store bootloader updates for multiple systems via external/internal memory. The mobile unit 408 may be placed on an update coupling pad 406 of a base station 402 which may be in communication with a “black box” master controller 450 of a piece of equipment 452. Therefore a human body 114 is not required as a transfer medium, rather close coupling of the mobile unit 408 and the coupling pad 406 of the base unit 402 provides for efficient wireless communications used in updating and/or testing equipment, machine, etc. In this way the mobile unit 408 may be used as a “mobile bootloader” 408 to update firmware in the equipment 452. For example, the mobile unit 408, acting as mobile bootloader, may do an integrity check of all electronics firmware versions in the equipment 452.

If a newer version of the machine firmware is found in the external/internal memory storage devices of the mobile unit 408, then firmware updates may be automatically loaded into the master controller 450 of the equipment 452. Upon firmware update completion, the mobile unit 408 may display a firmware update completion indication. In addition, the mobile unit 408 may be used as a diagnostic tool by reading and displaying operational and test information of the equipment 452. Thus, when a technician 454 is doing general inspection and/or mechanical repairs to the equipment 452 the mobile unit 452 may check the firmware of the master controller 450 and update if necessary. Similarly the technician 454 may use the mobile unit to receive and display operation of the equipment 452 during inspection and/or repair thereof. Connecting cables are not required between the mobile unit 408 and the master controller 450, and the technician 454 need not be actively involved with firmware updates to the master controller 450.

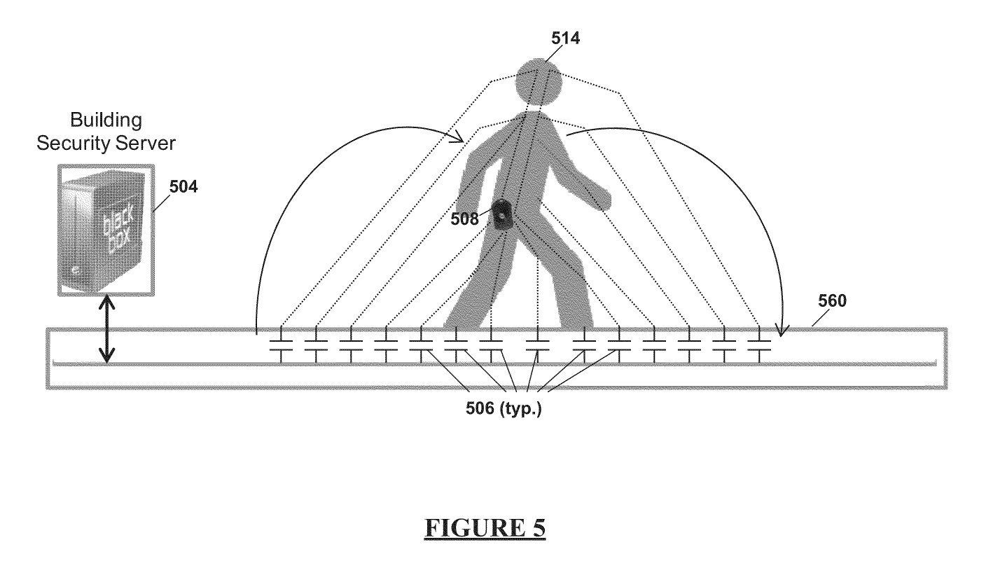

Referring to FIG. 5, depicted is a schematic block diagram of a BodyCom system used for supplying roaming data collection and/or distribution, according to another specific example embodiment of this disclosure. The BodyCom system can be implemented to supply roaming data collection and/or distribution. This may be accomplished by exchanging information between a mobile unit 508 on an individual 514 and a base unit transceiver/processor 504. A floor 560 in a building (not shown) may have a plurality of coupling elements 506 embedded therein and connected to the base unit transceiver/processor 504. This configuration may enable automatic short data exchanges, continuous personnel tracking, data distribution, and/or bootloader firmware updating.

A roaming data exchange can be implemented using a BodyCom system by integrating a plurality of coupling elements 506 into a building design, e.g., in the flooring, door handles, security keyless access stations, and the like. When a person 514 enters the building, the mobile unit 508 in his/her possession may begin communication with a central building security system (base unit transceiver/processor 504) via a BodyCom connection. Through this BodyCom connection information may be exchanged between the mobile unit 508 on the person 514 and the base unit 504 (building security server) only when the person 514 is within BodyCom communications range of a least one of the plurality of coupling elements 506. Passive bootloaders may also be loaded to the mobile unit 508 during this time. Bootloader updates may be relayed with BodyCom communications to the mobile unit 508 in multipack form when in a person's 504 possession. This allows for new firmware to be downloaded to an EEPROM through packet form till completed, e.g., as the person 514 walks through the building. Once the packet loading has finished, a new hex build may be rewrite into the firmware of the mobile unit 508.

Secure and Unsecure Areas of a Building

When employees enter the building and walk through the building, e.g., halls, offices, bathrooms, conference rooms, etc., secure information can only be viewed within secure areas. However, the secure information may be downloaded to the mobile units 508 as the employees make their way to their offices. Once in a secure area, e.g., office, access to the secure information may be viewed on the mobile unit 508, thereby giving visual access to the secure information. Without proper credentials passed via the building BodyCom security layer, encrypted data within the mobile may be un-viewable. Non-secure information may be exchanged between building networks and personal mobile devices (mobile units) 508 freely.

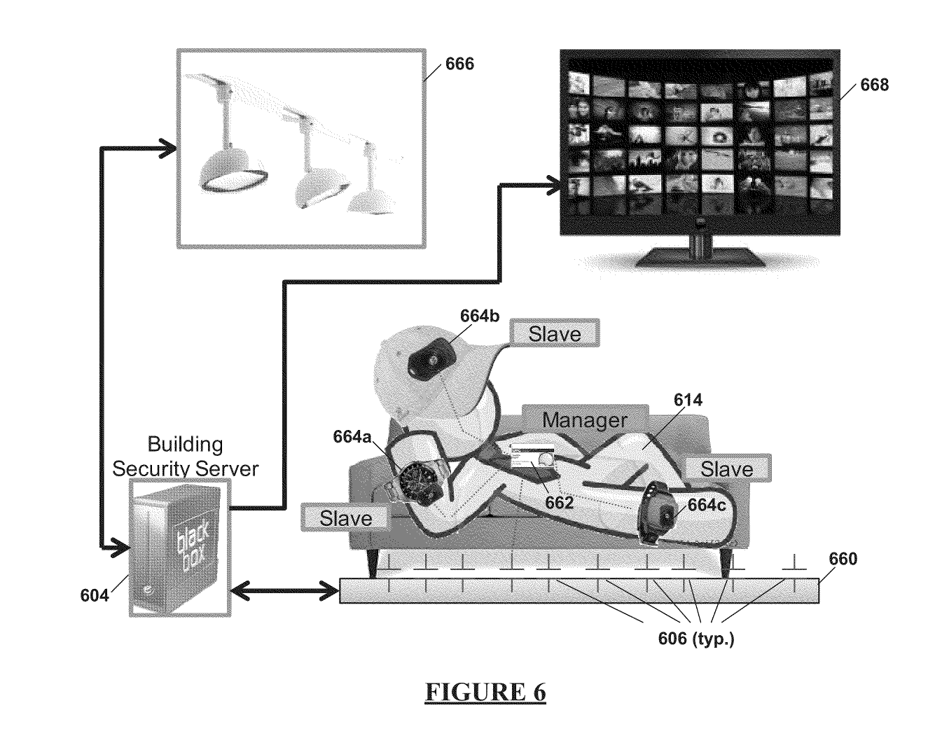

Referring to FIG. 6, depicted is a schematic block diagram of a BodyCom system comprising master, manager and slave devices, according to yet another specific example embodiment of this disclosure. A BodyCom system may comprise a master base unit 604 (building security server), a manager unit 662, at least one slave unit 664, and at least one coupling element 606. The at least one coupling element 606 may be part of a structure 660, e.g., floor, furniture and the like, proximate to the body 614. The manager unit 662 and the at least one slave unit 664 may be proximate to the body 614 of a person, and may communicate with the master base unit 604 (e.g., building security server) through the body 614 and any one or more of the at least one coupling elements 606.

A user may have multiple units (manager and slave units 662 and 664) on his/her body 614, all with BodyCom functionality. Implementation of a master, manager, slave system may create a priority communications chain, wherein the master unit 604 may be stationary, the manager unit 662 and the at least one slave unit 664 may be mobile with the user. The Master-Manager-Slave concept lets each slave unit 664 communicate with a user's personal “manager” mobile unit 662 in his/her possession that may handle periodic communication/storage of data from the slave units 664. When the user arrives back to his/her home, car or other major static location; a master base unit 604 associated with that location, may obtain updates from the manager unit 662. The master base unit 604 can request information from the manager unit 662 and/or the slave units 664. The manager unit 662 can request information from the slave units 664. The at least one slave unit(s) 664 collects data and responds to requests from the master base unit 604 and/or manager unit 662.

Using this master, manager, slave BodyCom system may allow collection of personal preferences and settings normally used by the wearer (body 614) to improve his/her life. For example, the manager unit 662 worn on the body 614 may handle occasional/varying/daily data exchanges and storage thereof from the at least one slave unit 664 data collection activities. At a certain time(s), e.g., when the user returns home, this stored data (information) in the manager unit 662 may be communicated via BodyCom to the house master base unit 604. Wherein the master base unit 604 then can handle the communicated data accordingly. E.g., information (data) from the slave units 664, stored in the manager unit 662 and forwarded to the base unit 604 may be used to control various devices, e.g., room lighting 666, home entertainment system(s) 668, climate control system (not shown), security system (not shown), and the like. In addition, multiple time stamps of events may be created and various communication methods available between the master, manager and slave units 604, 662 and 664, respectively.

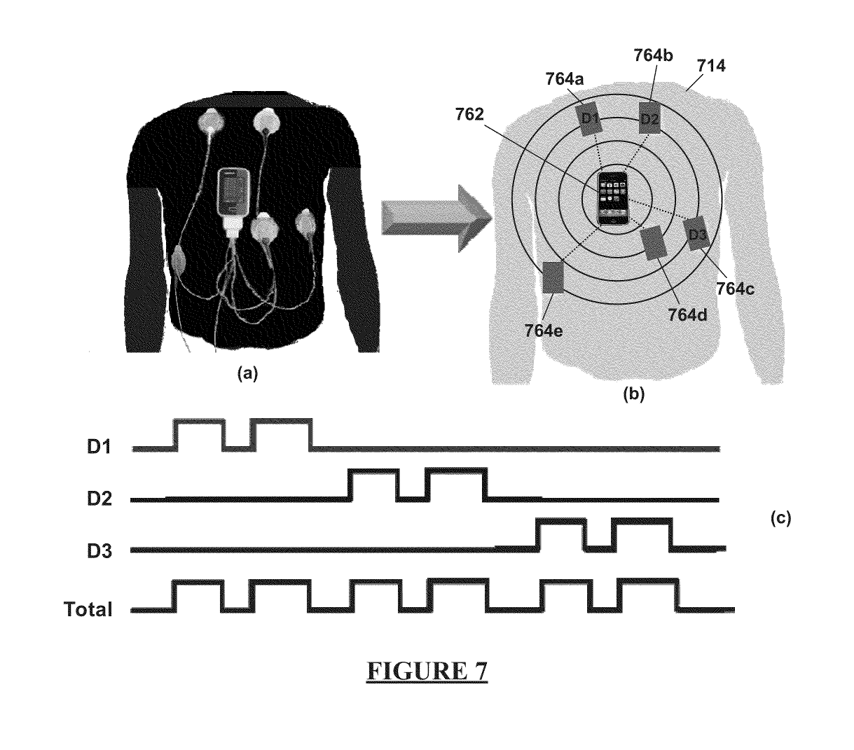

Referring to FIG. 7, depicted is a schematic block diagram of a BodyCom system using broadcast packet communications, according to still another specific example embodiment of this disclosure. BodyCom communication works by being within a tightly constrained communication state handler. As a result, when doing a broadcast from a manager unit 762 any slave units 764 within range will attempt to respond and their responses may be synchronized. By using this method a single large packet signal may be constructed by multiplexing (ORing) together the responses from the slave units 764. As shown in FIG. 7(c) the data response from each of the slave units 764 may be interlaced with the other responses and as a result data from each slave unit 764 may be time/position assigned. Thus allowing quick single broadcast/listen action while acquiring a large amount of data from multiple slave units 764.

During a sleep apnea study, a patient traditionally has to wear large cumbersome equipment with wires hanging all around them (FIG. 7(a)). By using the BodyCom system shown in FIG. 7(b) this becomes wireless. Since in this application the number of slave units 764 are known, extending the packet size to include data from all of the known slave units 764 allows making data transfers small and results in a large amount of information that can be gathered at a quicker rate. In a similar fashion, this packet packing method may also be used to relay specific messages to the slave units 764 based upon a “list location” that may be interpreted differently by each slave unit 764. Therefore unique encryption may expand functionality through firmware design. Broadcast packets may be decoded in the same fashion but in reverse, where the slave units 764 only care about data at specific byte location.

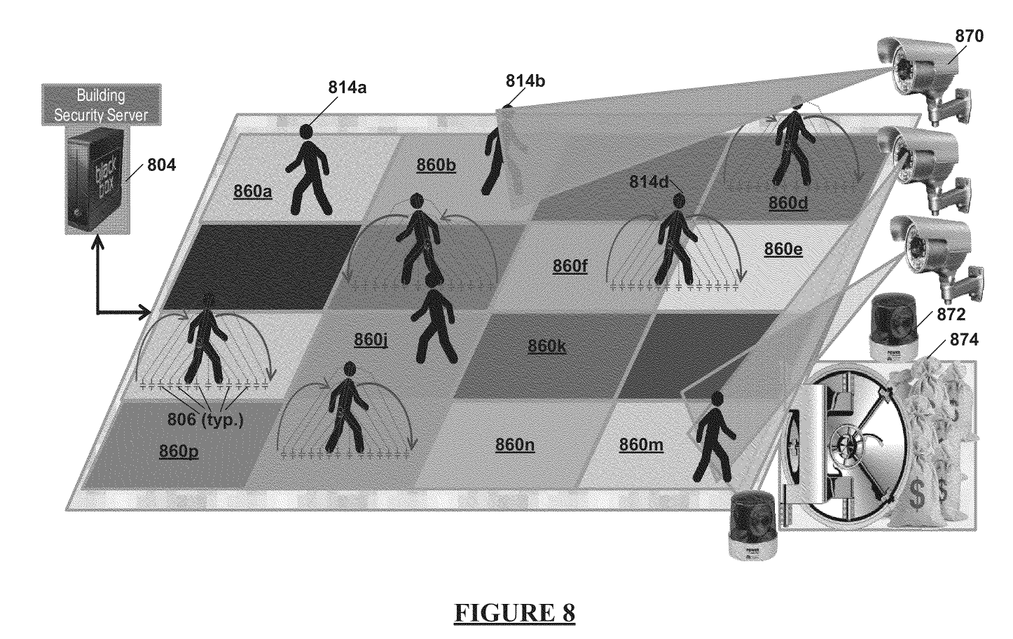

Referring to FIG. 8, depicted is a schematic block diagram of a BodyCom system implementation for localized tracking of people, according to another specific example embodiment of this disclosure. A floor of a building may have a plurality of areas 860, where each of the plurality of areas 860 may have at least one coupling element and proximity detector 806. The at least one coupling elements and proximity detectors 806 may be coupled to a base (master) unit transceiver/processor 804 (building security server). Wherein proximity detection of a person 814 by one or more of the at least one coupling elements and proximity detectors 806 may alert the base unit transceiver/processor 804 of the person 814 proximate to that proximity detector(s) in a respective area(s) 860. Once the person 814 has been so detected, security cameras 870 may be used for further observation of the detected person 814. An appropriate security camera(s) 870 may be selected and directionally oriented based upon the location of the area 860 having the proximity detection of the person 814. If the person 814 is in an area he or she is not authorized to be in, then appropriate alarms 872 and/or actions may be implemented.

The coupling elements and proximity detectors 806 may also provide BodyCom communications for those people 814 having mobile unit (not shown) on his or her person so that security protocols may be provided from that authorized person(s) back to the base unit transceiver/processor 804 (building security server) to indicate that the person 814 is authorized to be in that area of the building. For example within an art gallery all employee's and security may have BodyCom mobile (slave) units built into their badges. This will allow the security system to track individuals who do not possess the “access authorizing” badges.

Dynamic Priority Pairing

According to yet another specific example embodiment of this disclosure, dynamic priority pairing may be implemented using a BodyCom system. Using a priority pairing protocol with a BodyCom system would allow for multiple devices to exchange a single synchronized packet then assign priority to each device until no unique device still exists. A full-duplex communications implementation of the BodyCom system would be used. For example, a plurality of individuals meet for the first time. They all possess a BodyCom “digital business card.” These digital business cards use the BodyCom system to exchange information between people when they come within BodyCom contact range of each other. Thus physical interaction may be used to compile a business/personal address book with only as much work as, for example but is not limited to, shaking hands or fist bumping.

Example steps to achieve this are as follows:

| | | | | | |
|---|---|---|---|---|---|
| D1 | A9 | 89 | 11 | 12 | 1^{st} |
| D2 | B8 | 71 | 62 | 3F | 2^{nd} |
| D3 | C1 | D4 | 48 | 72 | 3^{rd} |
| Total | F9 | FD | 7B | 7F | Low Hex |

| Mask | Valid Find |
|---|---|
| 0 × 0F | None |
| 0 × 1F | D1—1^{st} |
| 0 × 4F | D3—2^{nd} |
| 0 × nF | None |
| 0 × 6F | D2—3^{rd} |

Sending a short known value packet may be used to synchronize timing. Everyone does broadcast which overlay each other in a (OR) fashion. Receive mixed packet information (Total from chart above). Use this packet index location for checking (7B-index: 3). Mask hex value with 0xOFh→0xEFh in a (XOR) method. If value equal to original; check analog front end (AFE) received signal strength indicator (RSSI) to see if anyone is transmitting. If no one else is transmitting, hold the line and begin transmitting. Through this method if another device should transmit next it can check its RSSI, detect a conflict and wait until other device has finished then transmit. This continues through the list till TIMEOUT where the index values may be locked in. It is also possible to read during 0 bits to see if anyone else is transmitting at that time to build priority. It is contemplated and within the scope of this disclosure that other and further steps may be used to achieve the same or similar results, and one having ordinary skill in digital electronics communications and programming and the benefit of this disclosure could readily provide such steps.

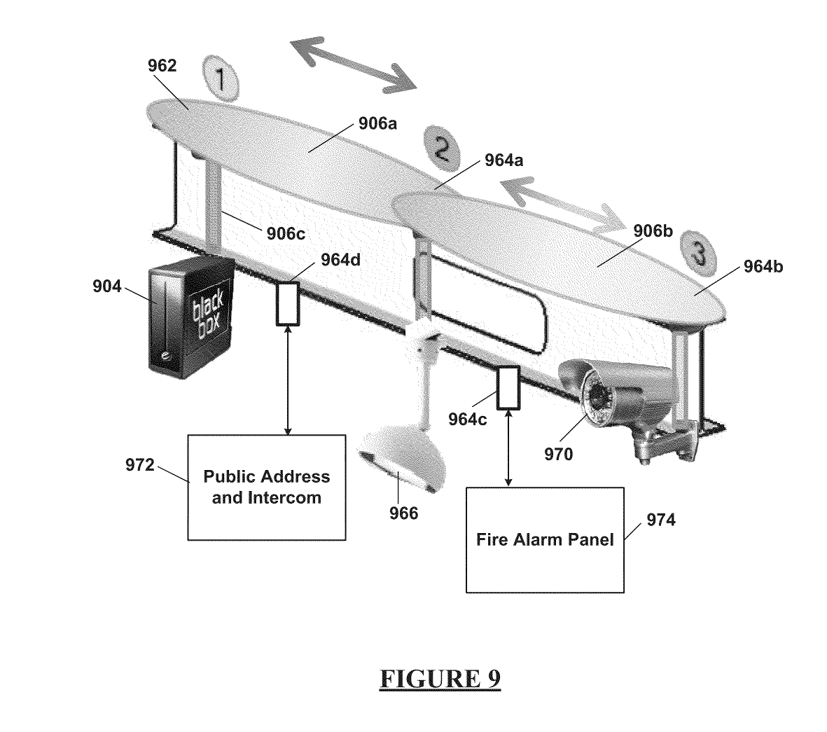

Referring to FIG. 9, depicted is a diagram of a BodyCom system providing infrastructure node communications, according to still another specific example embodiment of this disclosure. Building structures, e.g., steel beams, water pipes, electrical conduit, metal air conditioning plenums, and the like; may be used as BodyCom coupling elements 906. Therefore, the internal structures of a building may be used to carry BodyCom signals between small node points to chain together into a distributed communications and control system. Node (slave) units 964 may couple together using the BodyCom communications, and to a base or master unit 904. A manager unit 962 may be used to collect and distribute monitoring and control commands from the base unit 904 to the node units 964. The manager unit 962 is not mandatory as the node units 964 may communicate with the master unit 904 either directly or through intermediary node units 964 depending on distances therebetween. The node units 964 may be coupled to, monitor and/or control various pieces of equipment in the building (not shown), e.g., lights 966, security cameras 970, public address and intercom panels 972, fire alarm panels 974 and the like.

Position and Range Determination Using RSSI

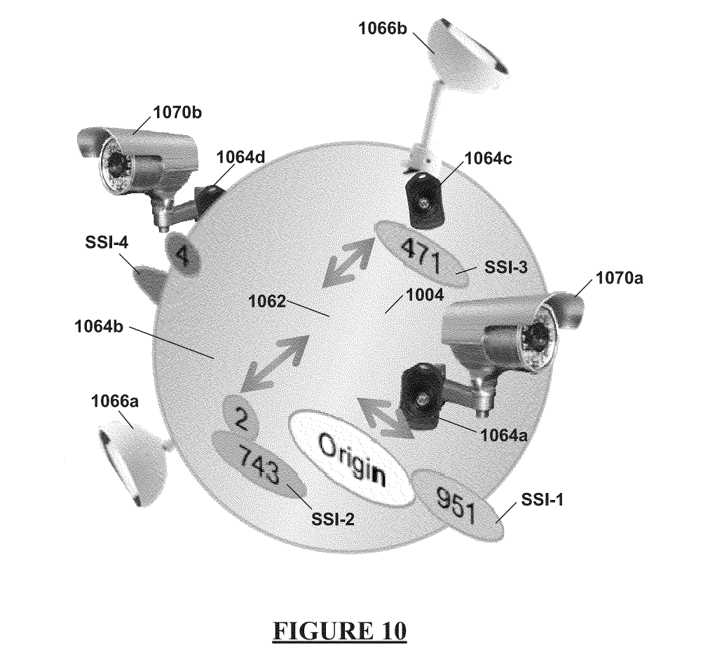

Referring to FIG. 10, depicted is a schematic block diagram of a position and range determination system based upon BodyCom communications received signal strength indication (RSSI), according to another specific example embodiment of this disclosure. An analog front end (AFE) device such as a Microchip MCP2030 or MCP2035 has signal strength indication (RSSI) available that may be used advantageously in a BodyCom communications enabled position and range determination system. More information on the use of the MCP2035 in BodyCom applications is provided in “Analog Front-End Device for BodyCom Applications” Microchip document no. DS22304A (2012), available at www.microchip.com, and is hereby incorporated by reference herein for all purposes. By using RSSI values supplied by the AFE a BodyCom enabled system may be able to create an estimated location and range value table for nearby units (nodes) 1064. This can be used in a number of ways. For example: When one master unit 1004 is communicating with multiple managers/slaves 1062/1064 it is capable of attaining dynamic RSSI values to determine basic distance deltas between the master unit 1004 and the managers/slaves 1062/1064. This may be accomplished by doing a simple data exchange built into current protocols, then on the master 1004 the locations/positions of the managers/slaves 1062/1064 may be saved and used for future communication. In addition, by using a dynamically scaling topography driver circuit it may be possible to increase/decrease signal strength of each manager unit 1062 and/or slave unit 1064 to operate within a specific RSSI range.

While embodiments of this disclosure have been depicted, described, and are defined by reference to example embodiments of the disclosure, such references do not imply a limitation on the disclosure, and no such limitation is to be inferred. The subject matter disclosed is capable of considerable modification, alteration, and equivalents in form and function, as will occur to those ordinarily skilled in the pertinent art and having the benefit of this disclosure. The depicted and described embodiments of this disclosure are examples only, and are not exhaustive of the scope of the disclosure.

What is claimed is:

1. A wireless transmission system, said system comprising:
a mobile unit comprising
a mobile capacitive coupling element,
a high frequency transmitter coupled to the mobile capacitive coupling element, and
a low frequency receiver coupled to the mobile capacitive coupling element; and
a base unit comprising
a base capacitive coupling element and proximity sensor,
a proximity detector coupled to the base capacitive coupling element and proximity sensor,
a low frequency transmitter coupled to the base capacitive coupling element and proximity sensor, and
a high frequency receiver coupled to the base capacitive coupling element and proximity sensor;
wherein when the mobile capacitive coupling element of the mobile unit is in close proximity to the base capacitive coupling element and proximity sensor, the proximity detector causes the base unit to transmit a low frequency signal that is received by the mobile unit, and the mobile unit to respond by transmitting a high frequency signal that is received by the base unit, whereby wireless communications is established therebetween.

2. The system according to claim 1, wherein the mobile unit stores bootloader updates for the base unit and, when in communications with the base unit, transfers the bootloader updates thereto.

3. The system according to claim 1, wherein the mobile unit receives operational and test information from the base unit.

4. The system according to claim 3, wherein the mobile unit stores the received operational and test information of the base unit.

5. The system according to claim 4, wherein the mobile unit displays the stored operational and test information of the base unit.

6. A method for wireless transmission, said method comprising the steps of:
providing a mobile unit comprising
a mobile capacitive coupling element,
a high frequency transmitter coupled to the mobile capacitive coupling element, and
a low frequency receiver coupled to the mobile capacitive coupling element; and
providing a base unit comprising
a base capacitive coupling element and proximity sensor,
a proximity detector coupled to the base capacitive coupling element and proximity sensor,
a low frequency transmitter coupled to the base capacitive coupling element and proximity sensor, and
a high frequency receiver coupled to the base capacitive coupling element and proximity sensor;
locating the mobile capacitive coupling element of the mobile unit in close proximity to the base capacitive coupling element and proximity sensor;
detecting the presence of the mobile unit in close proximity to the base capacitive coupling element and proximity sensor;
transmitting a low frequency signal from the base unit to the mobile unit; and
transmitting a high frequency signal from the mobile unit to the base unit, wherein wireless communications is established there between.

7. The method according to claim 6, further comprising the steps of:
storing bootloader updates for the base unit in the mobile unit; and
transferring the bootloader updates stored in the mobile unit to the base unit.

8. A wireless transmission system, said system comprising:
a mobile unit comprising
a mobile capacitive coupling element,
a high frequency transmitter coupled to the mobile capacitive coupling element, and
a low frequency receiver coupled to the mobile capacitive coupling element,
wherein the mobile capacitive coupling element is in close proximity to a user;
a plurality of base capacitive coupling elements and proximity sensors arranged in areas accessible to the user; and
a base unit comprising
at least one proximity detector coupled to respective ones of the plurality of base capacitive coupling elements and proximity sensors,
a low frequency transmitter selectively coupled to respective ones of the plurality of base capacitive coupling elements and proximity sensors, and
a high frequency receiver selectively coupled to the respective ones of the plurality of base capacitive coupling elements and proximity sensors;
wherein when the user is in close proximity to at least one of the plurality of base capacitive coupling elements and proximity sensors, at least one of the plurality of proximity sensors causes the base unit to transmit a low frequency signal through that at least one of the plurality of base capacitive coupling elements and proximity sensors that is received by the mobile unit, and the mobile unit to respond by transmitting a high frequency signal that is received by the base unit, whereby wireless communications is established therebetween.

9. The system according to claim 8, wherein the base unit stores bootloader updates for the mobile unit and, when in communications with the mobile unit, transfers the bootloader updates thereto.

10. The system according to claim 8, wherein the base unit determines a location of the user based upon which one of the plurality of base capacitive coupling elements and proximity sensors the user is proximate to.

11. The system according to claim 8, wherein the base unit determines a direction and speed of the user based upon which ones of the plurality of base capacitive coupling elements and proximity sensors the user is proximate to.

12. The system according to claim 8, wherein secure information is sent from the base unit to the mobile unit but not displayed on the mobile unit when the user is in an unsecured portion of the area.

13. The system according to claim 8, wherein secure information is sent from the base unit to the mobile unit and displayed on the mobile unit when the user is in a secure portion of the area.

14. The system according to claim 8, wherein non-secure information is sent from the base unit to the mobile unit and displayed on the mobile unit.

15. The system according to claim 8, wherein the base unit communicates with the mobile unit through the at least one of the plurality of base capacitive coupling elements and proximity sensors having proximity detection therefrom.

16. The system according to claim 8, wherein the at least one proximity detector selectively coupled to the respective ones of the plurality of master capacitive coupling elements and proximity sensors is a plurality of proximity detectors coupled to the respective ones of the plurality of master capacitive coupling elements and proximity sensors.

17. A method for wireless transmission, said method comprising the steps of:
providing a mobile unit comprising
a mobile capacitive coupling element,
a high frequency transmitter coupled to the mobile capacitive coupling element, and
a low frequency receiver coupled to the mobile capacitive coupling element,
wherein the mobile capacitive coupling element is in close proximity to a user;
providing a plurality of base capacitive coupling elements and proximity sensors arranged in areas accessible to the user; and
providing a base unit comprising
at least one proximity detector coupled to respective ones of the plurality of base capacitive coupling elements and proximity sensors,
a low frequency transmitter selectively coupled to respective ones of the plurality of base capacitive coupling elements and proximity sensors, and
a high frequency receiver selectively coupled to the respective ones of the plurality of base capacitive coupling elements and proximity sensors;
sensing when the user is in close proximity to at least one of the plurality of base capacitive coupling elements and proximity sensors;
transmitting a low frequency signal through that at least one of the plurality of base capacitive coupling elements and proximity sensors and over the user's body to the mobile unit; and
transmitting a high frequency signal from the mobile unit and over the user's body to the base unit, wherein wireless communications is established therebetween.

18. The method according to claim 17, further comprising the steps of:
providing a manager unit comprising
a manager capacitive coupling element,
a high frequency transmitter coupled to the manager capacitive coupling element, and
a low frequency receiver coupled to the manager capacitive coupling element,
wherein the manager capacitive coupling element is in close proximity to the user;

19. A wireless transmission system, said system comprising:
at least one slave unit, each of the at least one slave units comprising
a slave capacitive coupling element,
a high frequency transmitter coupled to the slave capacitive coupling element, and
a low frequency receiver coupled to the slave capacitive coupling element,
wherein the slave capacitive coupling element is in close proximity to a user;
a manager unit comprising
a manager capacitive coupling element,
a high frequency transmitter and receiver coupled to the manager capacitive coupling element, and
a low frequency transmitter and receiver coupled to the manager capacitive coupling element,
wherein the manager capacitive coupling element is in close proximity to the user;
a plurality of master capacitive coupling elements and proximity sensors arranged in areas accessible to the user; and
a master unit comprising
at least one proximity detector coupled to respective ones of the plurality of master capacitive coupling elements and proximity sensors,
a low frequency transmitter selectively coupled to at least one of the plurality of master capacitive coupling elements and proximity sensors, and
a high frequency receiver selectively coupled to the at least one of the plurality of master capacitive coupling elements and proximity sensors;
wherein when the user is in close proximity to at least one of the plurality of master capacitive coupling elements and proximity sensors, at least one of the plurality of proximity sensors causes the master unit to transmit a low frequency signal that is received by the manager unit, and the manager unit to respond by transmitting a high frequency signal that is received by the master unit, whereby wireless communications is established therebetween.

20. The system according to claim 19, further comprising the manager unit communicating with the at least one slave unit over the user's body.

21. The system according to claim 20, wherein the at least one slave unit and the manager unit collect personal preferences and setting of controllable appliances used by the user.

22. The system according to claim 21, wherein the controllable appliances are selected from the group consisting of room lighting, entertainment system, climate control, and security system.

23. The system according to claim 20, further comprising time stamping events communicated between the slave, manager and master units.

24. The system according to claim 19, wherein the at least one proximity detector selectively coupled to the respective ones of the plurality of master capacitive coupling elements and proximity sensors is a plurality of proximity detectors coupled to the respective ones of the plurality of master capacitive coupling elements and proximity sensors.

25. A wireless transmission system, said system comprising:
a plurality of slave units, each of the plurality of slave units comprising
a slave capacitive coupling element,
a high frequency transmitter coupled to the slave capacitive coupling element, and
a low frequency receiver coupled to the slave capacitive coupling element,
wherein the slave capacitive coupling element is in close proximity to a user; and
a manager unit comprising
a manager capacitive coupling element,
a high frequency transmitter and receiver coupled to the manager capacitive coupling element, and
a low frequency transmitter and receiver coupled to the manager capacitive coupling element,
wherein the manager capacitive coupling element is in close proximity to the user;
wherein the manager unit communicates with the plurality of slave units over the user's body.

26. The system according to claim 25, wherein responses from the plurality of slave units to the manager unit are synchronized.

27. The system according to claim 26, wherein synchronized responses from the plurality of slave units are packed into packets for reception by the manager unit.

28. The system according to claim 26, wherein synchronized response packets are encrypted.

29. A system for tracking authorized and unauthorized personnel, said system comprising:
a plurality of base capacitive coupling elements and proximity sensors arranged in an area;
a base unit comprising
at least one proximity detector coupled to respective ones of the plurality of base capacitive coupling elements and proximity sensors,
a low frequency transmitter selectively coupled to respective ones of the plurality of base capacitive coupling elements and proximity sensors, and
a high frequency receiver selectively coupled to the respective ones of the plurality of base capacitive coupling elements and proximity sensors;
when a person is in close proximity to at least one of the plurality of base capacitive coupling elements and proximity sensors, at least one of the plurality of proximity sensors causes the base unit to transmit a low frequency signal through that at least one of the plurality of base capacitive coupling elements and proximity sensors to a mobile unit wherein
if a high frequency signal response from the mobile unit is received by the base unit, then wireless communications is established therebetween and that person is authorized to be in the area of the respective one of the plurality of base capacitive coupling elements and proximity sensors, and
if no high frequency signal response from the mobile unit is received by the base unit, then that person is unauthorized to be in that area.

30. The system according to claim 29, wherein the mobile unit comprises a mobile capacitive coupling element, a high frequency transmitter coupled to the mobile capacitive coupling element, and a low frequency receiver coupled to the mobile capacitive coupling element, wherein the mobile capacitive coupling element is in close proximity to an authorized person.

31. The system according to claim 29, further comprising at least one security camera activated when an unauthorized person is in the area.

32. The system according to claim 29, further comprising at least one security alarm activated when an unauthorized person is in the area.

33. A method for tracking authorized and unauthorized personnel, said method comprising the steps of:
providing a plurality of base capacitive coupling elements and proximity sensors arranged in an area;
providing a base unit comprising
at least one proximity detector coupled to respective ones of the plurality of base capacitive coupling elements and proximity sensors,
a low frequency transmitter selectively coupled to respective ones of the plurality of base capacitive coupling elements and proximity sensors, and
a high frequency receiver selectively coupled to the respective ones of the plurality of base capacitive coupling elements and proximity sensors;
detecting when a person is in close proximity to at least one of the plurality of base capacitive coupling elements and proximity sensors;
transmitting a low frequency signal through that at least one of the plurality of base capacitive coupling elements and proximity sensors to a mobile unit;
determining whether a high frequency signal response from the mobile unit is received by the base unit,
if so, then that person is authorized to be in the area of the respective one of the plurality of base capacitive coupling elements and proximity sensors, and
if not, then that person is unauthorized to be in that area.

34. A wireless transmission system, said system comprising:
a plurality of units, each of the plurality of units comprising
a capacitive coupling element,
a high frequency transmitter and receiver coupled to the capacitive coupling element, and
a low frequency transmitter and receiver coupled to the capacitive coupling element;
each of the capacitive coupling elements is in close proximity to a respective user;
wherein at least two of the plurality of units communicate over the respective users' bodies.

35. The system according to claim 34, wherein the at least two of the plurality of units exchange a synchronized packet.

36. The system according to claim 34, wherein the synchronized packet has a priority assigned to each one of the plurality of units.

37. An infrastructure wireless communications system, said system comprising:
at least one slave node, each of the at least one slave nodes comprising
a slave node capacitive coupling element in close proximity to at least one radio frequency conductive structure in a building,
a high frequency transmitter coupled to the slave node capacitive coupling element, and
a low frequency receiver coupled to the slave node capacitive coupling element;
a master unit comprising
a master capacitive coupling element in close proximity to the at least one radio frequency conductive structure,
a low frequency transmitter selectively coupled to the master capacitive coupling element, and
a high frequency receiver selectively coupled to the master capacitive coupling element;
wherein the master unit transmits a low frequency signal over the at least one radio frequency conductive structure that is received by the at least one slave node unit, and the at least one slave node unit responds by transmitting a high frequency signal over the at least one radio frequency conductive structure that is received by the master unit, whereby wireless communications is established therebetween.

38. The system according to claim 37, further comprising:
a manager unit comprising
a manager capacitive coupling element in close proximity to the at least one radio frequency conductive structure,
a high frequency transmitter and receiver coupled to the capacitive coupling element, and
a low frequency transmitter and receiver coupled to the capacitive coupling element;
wherein the manager unit transmits a low frequency signal over the one radio frequency conductive structure that is received by the at least one slave node unit, and the at least one slave node unit responds by transmitting over the one radio frequency conductive structure a high frequency signal that is received by the manager unit, whereby wireless communications is established therebetween.

39. The system according to claim 38, wherein the manager unit communicates with the master unit over the at least one radio frequency conductive structure.

40. The system according to claim 38, wherein each of the at least one slave node units further comprises:
a low frequency transmitter coupled to the slave node capacitive coupling element, and
a high frequency receiver coupled to the slave node capacitive coupling element;
wherein at least two of the slave node units communicate over the at least one radio frequency conductive structure.

41. The system according to claim 37, wherein the at least one slave node unit is coupled to and controls equipment in the building.

42. The system according to claim 40, wherein the equipment is selected from the group consisting of lights, security cameras, public address panel, intercom panel, and fire alarm panel.

43. The according to claim 40, further comprising each high and low frequency receiver has a received signal strength indication (RSSI), wherein received signal strength is available from of the at least one slave node unit and the manager unit to the master unit for determining distances and locations thereof.

44. A method for wirelessly communicating in a building, said method comprising the steps of:
providing at least one slave node, each of the at least one slave nodes comprising
a slave node capacitive coupling element in close proximity to at least one radio frequency conductive structure in a building,
a high frequency transmitter coupled to the slave node capacitive coupling element, and
a low frequency receiver coupled to the slave node capacitive coupling element;
providing a master unit comprising
a master capacitive coupling element in close proximity to the at least one radio frequency conductive structure,
a low frequency transmitter selectively coupled to the master capacitive coupling element, and
a high frequency receiver selectively coupled to the master capacitive coupling element;
transmitting a low frequency signal over the at least one radio frequency conductive structure with the master unit;
receiving the low frequency signal with the at least one slave node unit; and
transmitting a high frequency signal over the at least one radio frequency conductive structure with the at least one slave node unit.

45. The method according to claim 44, further comprising the steps of:
providing a manager unit comprising
a manager capacitive coupling element in close proximity to the at least one radio frequency conductive structure,
a high frequency transmitter and receiver coupled to the capacitive coupling element, and
a low frequency transmitter and receiver coupled to the capacitive coupling element;
transmitting a low frequency signal over the at least one radio frequency conductive structure with the manager unit;
receiving the low frequency signal with the at least one slave node unit; and
transmitting a high frequency signal over the at least one radio frequency conductive structure with the at least one slave node unit.

46. The method according to claim 45, further comprising the step of communicating between the manager unit and the master unit over the at least one radio frequency conductive structure.

47. The method according to claim 44, further comprising the steps of:
coupling respective ones of the at least one slave node unit to building equipment; and
controlling the building equipment with the respective ones of the at least one slave node units.
